(19) United States
(12) Patent Application Publication
(10) Pub. No.: US 2018/0188201 A1
(43) Pub. Date: Jul. 5, 2018

(54) BIO-SENSOR AND BIO-SENSOR ARRAY

(71) Applicant: Seoul National University R&DB Foundation, Seoul (KR)

(72) Inventors: Young June Park, Seoul (KR); Seong Wook Choi, Seoul (KR)

(21) Appl. No.: 15/740,690

(22) PCT Filed: Jun. 22, 2016
(86) PCT No.: PCT/KR2016/006620

§ 371 Date: Dec. 28, 2017

(30) Foreign Application Priority Data
Jun. 29, 2015 (KR) 10-2015-0092111

(51) Int. Cl. G01N 27/327

(52) U.S. Cl. CPC G01N 27/3277; G01N 27/3273

(57) ABSTRACT

A bio-sensor according to embodiments of the present invention is a bio-sensor configured to detect a specific target; the bio-sensor includes a substrate, a first electrode and a second electrode disposed on the substrate and not electrically connected to each other, and probes disposed on the substrate, the first electrode, and the second electrode and coupled to the target.

### CROSS-REFERENCE TO RELATED APPLICATIONS

The Present application is a national phase of the International Patent Application PCT/KR2016/006620, now published as WO 2017/003126, filed on Jun. 22, 2016, which in turn claims priority from and benefit of the Korean Patent Application No. 10-2015-0092111, filed on Jun. 29, 2015. The disclosure of each of the above-identified applications is incorporated herein by reference.

### BACKGROUND

A bio-sensor configured according to principles of related art uses three electrodes. These three electrodes are referred to as a working electrode, a reference electrode, and a counter electrode. The presence of a target and/or a concentration of the target is detected, with such bio-sensor, by generating a voltage between the working electrode and the reference electrode to provide a target voltage and detecting a value of current obtained from the working electrode and the counter electrode.

### SUMMARY OF THE INVENTION

### Technical Problem

In a case, in which the presence of a target object and/or a concentration of the target object included in an electrolyte solution should be detected by a bio-sensor according to related art, a voltage should be applied to any one of a working electrode and a reference electrode in an operational state in which a probe with the bio-sensor is immersed in the electrolyte solution.

In the case, in which the voltage is applied through the probe, it is difficult to apply a target voltage thereto since a voltage drop (IR drop) occurs when the electrolyte solution is away from the probe (due to electrical resistance of the electrolyte solution). Since the application of the target voltage is uncertain, it is not clear whether a measurement result indicating the detection is due to an instrument error or the voltage drop, and thus it is difficult to ensure accuracy of the detection result.

Furthermore, a probe material (selectively coupled to a target to be detected) is formed, patterned, and selectively disposed on a conventional bio-sensor. Accordingly, accuracy of the detection is reduced due to a change in a physical property of the probe material during the patterning process.

The present embodiments solve the above-described problems of the related art, and one main purpose of the embodiments is to provide a bio-sensor capable of accurately applying voltage using two electrodes. In addition, another main purpose of the embodiments is to provide a bio-sensor, in which detection accuracy is not reduced (because a process, in which a probe material is selectively disposed thereon, is not performed).

### Technical Solution

One embodiment of the present invention provides a bio-sensor configured to detect a target, where the bio-sensor includes a substrate, a first electrode, and a second electrode that are disposed on the substrate and that are not electrically connected to each other. The embodiment also includes probes disposed on the substrate, the first electrode, and the second electrode and coupled to the target.

An embodiment of the present invention also provides a bio-sensor configured to detect a target which includes a biomaterial. Such bio-sensor includes a substrate, a first electrode and a second electrode that are disposed on the substrate and are not electrically connected to each other, and having different surface areas; as well as probes disposed on the substrate, a detection electrode, and a common electrode and coupled to the target.

A related embodiment of the present invention provides a bio-sensor array in which bio-sensors configured to detect a target (which includes a biomaterial) are disposed; the bio-sensor array including a substrate, a plurality of island electrodes disposed on the substrate; a common electrode configured to surround the plurality of island electrodes disposed on the substrate and not in electrical contact with the plurality of island electrodes; as well as probes randomly disposed on the substrate, the plurality of island electrodes, and the common electrode and specifically coupled to the target. Here, surface areas of the plurality of island electrodes are smaller than that of the common electrode.

### Advantageous Effects

According to the present embodiment, since a first electrode and a second electrode with different surface areas are used, an accurate voltage can be reliable applied to the electrodes even though three electrodes are not used. Therefore, there is an advantage in that a voltage (the value of which is more accurate than that of related art) is economically generated and used for detection of the target material.

Furthermore, since a voltage between an electrode and a solution can be also accurately adjusted according to the present embodiment, there is an advantage in that a change in faradaic current can be as accurately detected.

In contradistinction with related art, and since a probe is not being patterned, according to the present embodiment, a possibility that that physical properties of the probe will be changed does not present any concern. Therefore, there is an advantage in that a target material can be more accurately detected in comparison to a related art.

### BRIEF DESCRIPTION OF THE DRAWINGS

FIG. 1 is a top view illustrating a bio-sensor according to an embodiment of the present invention.

FIG. 2 is a schematic cross-sectional view illustrating the bio-sensor according to the embodiment.

FIG. 3A is a schematic view illustrating an electrical double layer formed between first and second electrodes and an electrolyte, and FIG. 3B is a view illustrating an example of a state in which the electrical double layer is formed from an electrical viewpoint.

FIG. 4 is a view illustrating an example of a state in which targets (T) are coupled to probes (P).

FIG. 5 is a schematic view illustrating the bio-sensor according to the present embodiment formed in an array type.

### DETAILED DESCRIPTION

While the description for the present invention only discloses embodiments for structurally and functionally describing the present invention, a scope of the present invention is not to be interpreted as being limited to the described embodiments. That is, since the embodiments may be variably modified and have various forms, it should be understood that the scope of the present invention includes various equivalents that may be realized in the spirit of the idea of the present invention.

Meanwhile, terms used in the present invention should be interpreted as follows.

While the terms “first,” “second,” and the like are used herein to distinguish one element from another, the scope of the present invention is not to be limited by these relative terms. For example, a first element could be termed a second element, and a second element could be termed a first element.

Elements or features of the invention referred to as singular may include and/or imply one or more of such elements or features, unless the context clearly indicates otherwise. It should be further understood that the terms “comprise,” “comprising,” “include,” or “including,” when used herein, specify the presence of stated features, numbers, steps, operations, elements, components, or groups thereof, but do not preclude the presence or addition of one or more other features, numbers, steps, operations, elements, components, or groups thereof.

The expression “and/or,” when describing the embodiments of the present invention, is used to refer to all or one of the identified items. For example, the expression “A and/or B” should be understood as “A,” and “B,” and “A and B.”

Unless otherwise defined, each of the terms used herein has the same meaning as commonly understood by one of ordinarily skill in the art to which this invention relates. It should be further understood that terms, such as those defined in commonly-used dictionaries, should be interpreted as having a meaning that is consistent with their meaning in the context of the relevant art, and such terms are not to be interpreted in an idealized or overly-formal sense unless expressly so defined herein.

Sizes, heights, thicknesses, and the like in the drawings referred to when describing the embodiment of the present invention are not to scale, but may be intentionally exaggerated and expressed for convenience of description and to facilitate understanding, and are not enlarged or shrunk according to any ratio. In addition, some elements illustrated in the drawings may be intentionally expressed as being smaller, and the other elements may be intentionally expressed as being larger.

The expression “A and B are coupled” is used in the present disclosure to refer to a case in which A and B are physically coupled in a state in which chemical structures thereof are maintained, and also refers to a case in which A and B react and physical or chemical structures thereof are changed.

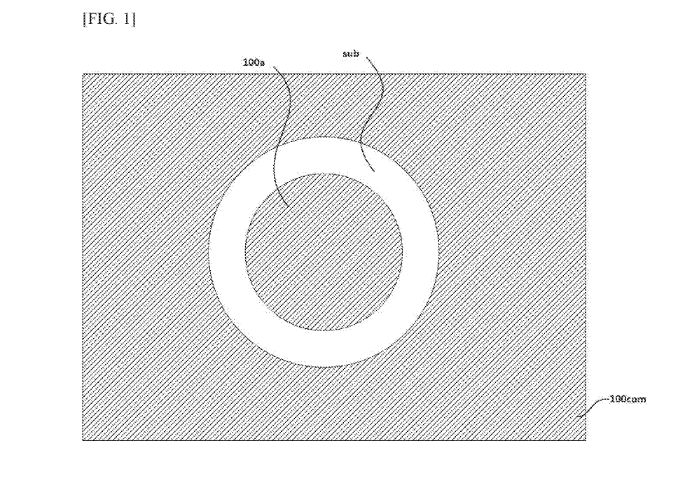

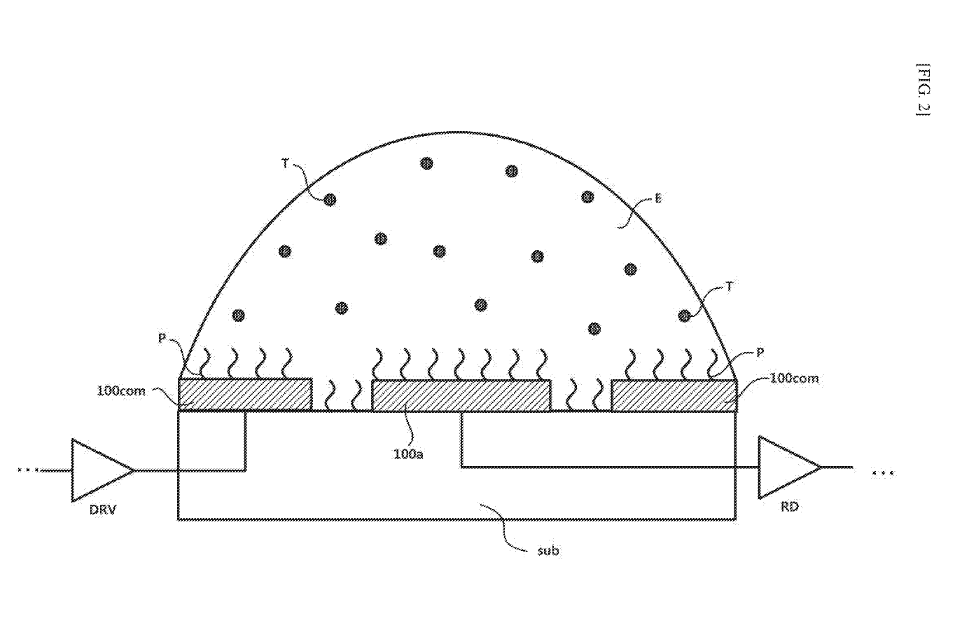

Hereinafter, a bio-sensor according to the present embodiment will be described with reference to the accompanying drawings. FIG. 1 is a top view illustrating a bio-sensor according to an embodiment of the present invention, and FIG. 2 is a schematic cross-sectional view illustrating the bio-sensor according to the embodiment. Referring to FIGS. 1 and 2, the bio-sensor according to the embodiment is a bio-sensor for detecting a specific target, and the bio-sensor includes a substrate, a first electrode and a second electrode disposed on the substrate and not electrically connected to each other, and probes disposed on the substrate, the first electrode, and the second electrode to be coupled to a target.

The bio-sensor according to the present embodiment is the bio-sensor for detecting the specific target, and the bio-sensor includes the substrate, the first electrode and the second electrode disposed on the substrate, not electrically connected to each other, and having different surface areas, and the probes disposed on the substrate, a detection electrode, and a common electrode to be coupled to the target.

A first electrode 100a and a second electrode 100com are located on one surface of a substrate sub. In addition, probes P may be located on the same surface of the substrate sub. The substrate comes into contact with an electrolyte solution E including targets T. Accordingly, the substrate is formed of a material that does not electrochemically react with the electrolyte solution E even when it is in contact with the electrolyte solution E. For example, the substrate sub is formed of glass. As another example, the bio-sensor may be formed through semiconductor processing, and then according to an embodiment, the substrate may be a silicon substrate.

The first electrode 100a is located the one surface of the substrate and is not electrically connected to the second electrode 100com. The second electrode 100com is located on the same surface of the substrate like the first electrode 100a. A surface area of the first electrode 100a (configured to come into contact with the electrolyte) is different from that of the second electrode 100com (and also configured to come into contact with the electrolyte). For example, the surface area of the second electrode 100com configured to come into contact with the electrolyte solution E may be ten times or even more, greater than that of the first electrode 100a configured to come into contact with the electrolyte solution E.

The first electrode 100a and the second electrode 100com come into contact with the electrolyte solution E and are used to apply a voltage to the electrolyte solution E. Accordingly, the first electrode 100a and the second electrode 100com should be formed of a material that is not corroded when in contact with the electrolyte solution E. In addition, an electrical double layer is formed on a surface of each of the first electrode 100a and the second electrode 100com which come into contact with the electrolyte solution E. Accordingly, both the first electrode 100a and the second electrode 100com are formed of a material configured to form the electrical double layer when in contact with the electrolyte solution E.

In one embodiment, both the first electrode 100a and the second electrode 100com are formed of gold (Au). In a related embodiment, a first electrode 100a and a second electrode 100com may be formed of a metal including any of silver (Ag), mercury (Hg), platinum (Pt), and silver chloride (AgCl).

The probes P may be a material specifically coupled to the target T to be detected using the bio-sensor. In one embodiment, when the target T is deoxyribonucleic acid (DNA) having a specific base sequence, the probes P include a material having a sequence which complementarily binds to the base sequence of the target. Similarly, when DNA, ribonucleic acid (RNA), a protein, a hormone, an antigen, or the like is desired to be detected, a material specifically bound to the DNA, the RNA, the protein, the hormone, the antigen, or the like is used in the probes P.

The probes P are not patterned on the substrate sub and the first and second electrodes 100a and 100com formed on one surface of the substrate, but are randomly disposed. As one embodiment, the probes P may be immobilized and formed on the substrate. For example, an immobilization process may be performed by applying a solution including the probes P to a surface of the substrate, incubating the substrate, and washing the solution. As another example, the immobilization process may be performed by immersing the substrate sub in a solution including the probes P, and removing the solution through evaporation. As another example, the probes P may be disposed by being sprayed, and as another example, the probes P may be randomly disposed through a printing process such as an inkjet printing process using a nozzle and a roll to roll printing process. Accordingly, since a patterning process for selectively disposing the probes P is not required, unlike a related art, material properties of the probes P are not degraded. Accordingly, detection properties of the bio-sensor may be improved.

In the embodiment in which the first electrode 100a and the second electrode 100com are formed of gold (Au), as ends of the probes are processed with a thiol group, adhesion and immobilization between the probes P and the first and second electrodes 100a and 100com may be improved.

A stimulating source DRV is connected to the second electrode 100com and electrically stimulates the second electrode 100com. Readout circuitry RD is connected to the first electrode 100a and receives a detection signal, which is changed according to whether the probes P are coupled to the targets T, from the first electrode 100a. In the illustrated embodiment, the stimulating source DRV configured to electrically stimulate the second electrode 100com is connected to the second electrode 100com, and the readout circuitry RD is connected to the first electrode 100a. However, in another embodiment which is not illustrated, a stimulating source DRV may be connected to a first electrode 100a, and readout circuitry RD may be electrically connected to a second electrode 100com.

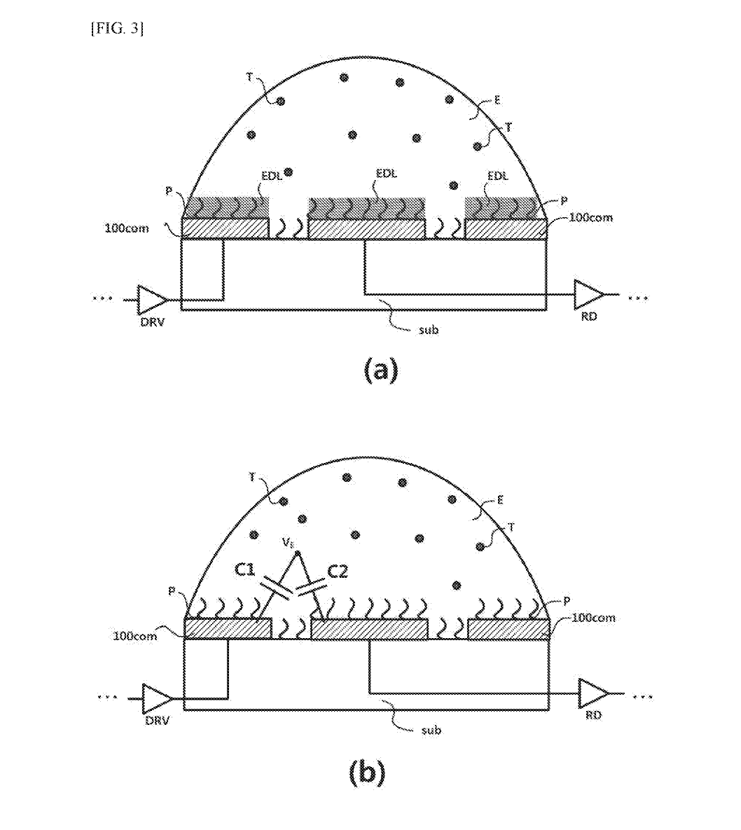

Hereinafter, operation of the bio-sensor having the above-described structure will be described. Continuously referring to FIG. 3A, the electrolyte solution E including the targets T to be detected by the bio-sensor is placed on the bio-sensor. Negative and positive ions in the electrolyte solution E are dissociated, and when the electrolyte solution E comes into contact with the first electrode 100a and the second electrode 100com, as illustrated in FIG. 3A, the negative and positive ions are disposed on surfaces of the first electrode 100a and the second electrode 100com in a layered shape and form an electrical double layer EDL.

When the electrical double layer EDL is formed, the electrolyte E functions as one electrode of a capacitor, the first electrode 100a or the second electrode 100com functions as the other electrode of the capacitor, and the electrical double layer EDL functions as a dielectric material of the capacitor. Capacitance C of the capacitor formed as described above may be calculated by Equation 1.

$$C = ɛ \frac{A}{d} \qquad [ Equation 1 ]$$

A separation distance d between the electrodes of the capacitor is a distance between the electrolyte solution E and the first electrode 100a or the second electrode 100com, and corresponds to several angstroms (Å) to several tens of angstroms (Å), which is a thickness of the electrical double layer EDL, because the electrical double layer EDL is interposed between the electrodes and the electrolyte solution.

In addition, when it is assumed that the thicknesses of electrical double layers EDL formed on the surfaces of the first electrode 100a and the second electrode 100com are the same, capacitance C1 generated between the first electrode 100a and the electrolyte solution E and capacitance C2 generated between the second electrode 100com and the electrolyte solution E correspond to surface areas of the first electrode 100a and the second electrode 100com. As one embodiment, when the surface area of the second electrode 100com is ten times greater than that of the first electrode 100a, a value of the capacitance C2 is calculated to be ten times that of the capacitance C1.

This is electrically illustrated in FIG. 3B. When the stimulating source DRV sends an electrical signal corresponding to a voltage V_{drv} to the second electrode 100com, an electric potential V_{E} of the electrolyte solution E may be calculated by the following Equation 2.

$${V}_{E} = {V}_{drv} \frac{C 1}{C 1 + C 2} \qquad [ Equation 2 ]$$

That is, the electric potential V_{E} of the electrolyte solution E has a value corresponding to the capacitance C1 of a capacitor formed at the first electrode 100a and the capacitance C2 of a capacitor formed at the second electrode 100com. The capacitances of the capacitors are proportional to areas of the electrodes in contact with the electrolyte, as seen in Equation 1. Accordingly, when the surface area of the first electrode 100com in contact with the electrolyte solution E is very small in comparison to that of the second electrode 100com in contact with the electrolyte solution E, the corresponding values of the capacitances have the same relation as the surface areas, and thus Equation 2 may approximate the following Equation 3.

$${V}_{E} = {V}_{drv} \frac{\frac{C 1}{C 1}}{\frac{C 1}{C 1} + \frac{C 2}{C 1}} = {V}_{drv} \qquad [ Equation 3 ]$$

That is, when the surface area of the first electrode 100a is very small in comparison to that of the second electrode 100com and electrical stimulation is provided through the second electrode, the electric potential V_{E} of the electrolyte may be seen as approximating the electric potential V_{drv} of an electrical signal provided by the stimulating source.

Furthermore, when the bio-sensor according to the embodiment is formed by forming the second electrode 100com, which is a common electrode, to cover an area of a large die through a semiconductor process, and forming the first electrode 100a to have a very small size, a very small difference between the electric potential V_{E} of the electrolyte solution E and the voltage V_{drv} provided by the stimulating source DRV is maintained.

As one embodiment, in addition, when the surface area of the first electrode 100a is 1/20 of that of the second electrode 100com, the electric potential V_{E} of the electrolyte solution E is calculated as 0.95 V_{drv} through Equation 3. In another embodiment, when a surface area of a first electrode 100a is 1/10 of that of a second electrode 100com, an electric potential V_{E} of an electrolyte solution E is calculated as 0.91 V_{drv} through the Equation 3. Accordingly, the bio-sensor according to the embodiment has an advantage in that an electric potential of the electrolyte may be constantly maintained without a voltage drop occurring at a bio-sensor including three electrodes according to the related art.

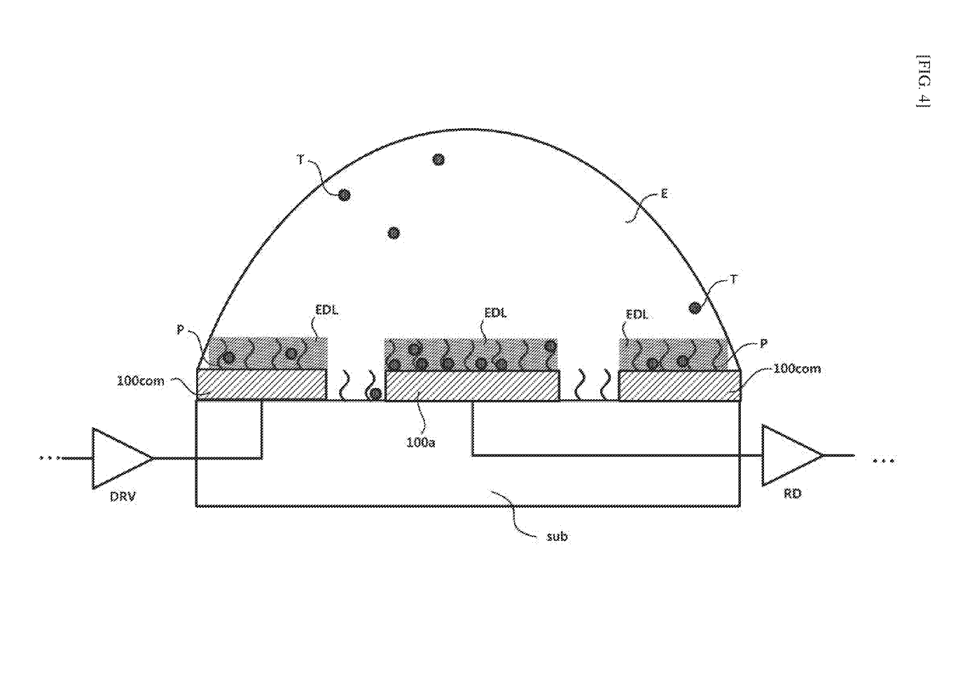

FIG. 4 is a view illustrating an example of a state in which the targets T are coupled to the probes P, and examples in which the targets T are detected will be described with reference to FIG. 4. As one embodiment, since the targets T react with the probes P, a distribution of molecules which cause redox of the surface of the first electrode 100a and/or the second electrode 100com changes, and a change in current may be accordingly detected.

In an embodiment in which the targets T are matrix metalloproteinase 9 (MMP9), which is a cancer metastasis bio-marker, and the probes are methylene blue (MB), which is a peptide having Gly-Pro-Leu-Gly-Met-Trp-Ser-Arg-Cys bonding, when the targets T are not included in the electrolyte solution E, a redox reaction occurs at the electrode due to the MB formed at an end of each of the probes P, and accordingly, a faradaic current is supplied to the electrode.

When the target T is included in the electrolyte solution E, MMP9, which is the target, is coupled to the peptide, which is the probe, and bonding between the Gly and Met of an end of the peptide is broken, and thus the MB is disconnected form the peptide, which is the probe. Accordingly, since the redox reaction occurring due to MB decreases, the faradaic current changes, and thus the presence of the target and/or a concentration of the target may be detected by detecting the change in the faradaic current.

In another embodiment, probes P are coupled to a targets T in an electrical double layer formed by an electrolyte solution E in contact with a first electrode 100a and a second electrode 100com. Although a dielectric layer of a capacitor formed in the first electrode 100a before the probes P are coupled to the targets T is formed as only the electrical double layer, when the probes P are coupled to the targets T, since the electric double layer together with a target material is accommodated in the dielectric layer, a capacitance value of the capacitor formed in the first electrode 100a changes.

When the electric potential V_{E} of the electrolyte solution E is applied to the capacitor formed at the first electrode 100a, an electrical signal iₛₑₙₛₑ provided by the bio-sensor detecting the target T may be expressed by the following Equation 4.

$${i}_{sense} = Δ C \frac{{dV}_{E}}{dt} \qquad [ Equation 4 ]$$

That is, a change in capacitance caused by the targets T coupled to the probes P may change a current value, the readout circuitry RD may detect the change in the current value, a signal may be processed, and thus whether the targets T is included in the electrolyte E or a concentration of the targets may be checked.

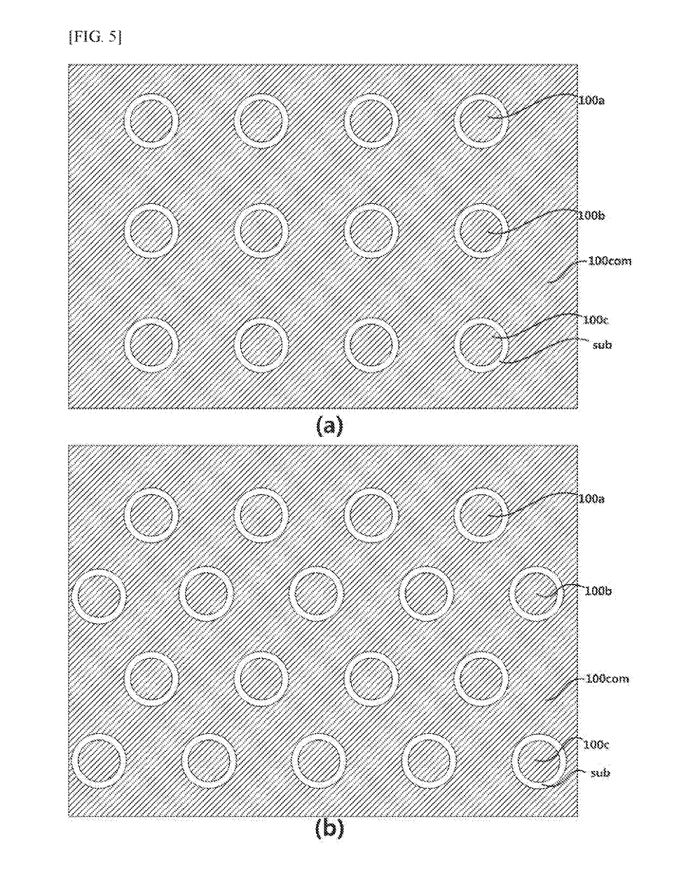

FIG. 5 is a schematic view illustrating the bio-sensor according to the embodiment formed in an array type. Referring to FIG. 5, a bio-sensor array according to the embodiment includes a plurality of island electrodes 100a, 100b, and 100c and a common electrode 100com formed to cover a substrate sub and not configured to be in electrical contact with the island electrodes, and probes P (see FIGS. 1 to 4) are formed on the island electrodes, the substrate, and the common electrode.

FIG. 5A is a view illustrating a bio-sensor array in which the island electrodes 100a, 100b, and 100c are disposed in a rectangular shape, and FIG. 5B is a view illustrating a bio-sensor array in which the island electrodes 100a, 100b, and 100c are diagonally disposed. As described with reference to Equation 3, when a surface area of the common electrode 100com in contact with an electrolyte E (see FIGS. 1 to 4) is greater than those of the island electrodes 100a, 100b, and 100c, an electric potential of the electrolyte approximates an electric potential provided by a stimulating source DRV (see FIG. 2). Therefore, according to the embodiment, the surface area of the common electrode 100com may increase in comparison to those of the island electrodes 100a, 100b, and 100c, and thus there is an advantage in that an electric potential V_{E} of the electrolyte configured to come into contact with the common electrode 100com and the island electrodes 100a, 100b, and 100c may be maintained to approximate a voltage V_{drv} of an electrical signal provided by the stimulating source.

Furthermore, according to the embodiments illustrated in FIGS. 5A and 5B, since detecting a target object may be simultaneously performed by the island electrodes 100a, 100b, and 100c configured to form the bio-sensor formed, there is an advantage in that accuracy and sensitivity of the detection of the target materials may be improved.

While the present invention has been disclosed with reference to the embodiments illustrated in the accompanying drawings to facilitate understanding the present invention, it should be understood by those skilled in the art that the embodiments are only examples for implementing the present invention, and various modifications and equivalent other embodiments may be made. Therefore, the true technical protection scope of the present invention should be defined by the appended claims.

### INDUSTRIAL APPLICABILITY

Industrial applicability has been described above.

1. A bio-sensor configured to detect a target, the bio-sensor comprising:
a substrate;
a first electrode and a second electrode disposed on the substrate and not electrically connected to each other; and
probes disposed on the substrate, the first electrode, and the second electrode and coupled to the target.

2. The bio-sensor of claim 1, wherein each of the probes includes a material specifically coupled to the target.

3. The bio-sensor of claim 1, wherein the probes are randomly disposed on the substrate, the first electrode, and the second electrode.

4. The bio-sensor of claim 1, wherein the probes are disposed on the substrate, the first electrode, and the second electrode by being immobilized or sprayed.

5. The bio-sensor of claim 1, configured to detect the target that has been included in an electrolyte solution and supplied to the bio-sensor in said electrolyte solution.

6. The bio-sensor of claim 1, wherein the first electrode and the second electrode are formed of gold (Au).

7. The bio-sensor of claim 1, wherein the first electrode and the second electrode include a metal electrode that includes silver, mercury, platinum, or silver chloride (AgCl).

8. The bio-sensor of claim 1, wherein:
one of the first and second electrodes is electrically connected to a stimulating source configured to provide electrical stimulation; and
the other of the first and second electrodes is electrically connected to readout circuitry configured to read a detection signal that varies according to whether the probe is or is not coupled to the target.

9. A bio-sensor configured to detect a target that is a biomaterial, the bio-sensor comprising:
a substrate;
a first electrode and a second electrode disposed on the substrate and not electrically connected to each other, and having different surface areas; and
probes disposed on the substrate, the detection electrode, and the common electrode and coupled to the target.

10. The bio-sensor of claim 9, configured to detect the target that has been included in an electrolyte solution and provided to the bio-sensor in said the electrolyte solution.

11. The bio-sensor of claim 9, wherein a surface area of one of the first and second electrodes is at least ten times greater than that of another of the first and second electrodes.

12. The bio-sensor of claim 9, wherein:
the first electrode is an island type electrode; and
the second electrode is a common electrode configured to surround the first electrode.

13. The bio-sensor of claim 9, wherein each of the probes includes a material specifically coupled to the target.

14. The bio-sensor of claim 9, wherein the probes are randomly disposed on the substrate, the first electrode, and the second electrode.

15. The bio-sensor of claim 9, wherein the electrode is formed of gold (Au).

16. The bio-sensor of claim 9, wherein the electrodes include a metal electrode that includes silver, mercury, platinum, or silver chloride (AgCl).

17. The bio-sensor of claim 9, wherein:
one of the first and second electrodes is electrically connected to a stimulating source configured to provide electrical stimulation; and
another of the first and second electrodes is electrically connected to readout circuitry configured to read a detection signal changed according to whether the probe is or is not coupled to the target.

18. A bio-sensor array in which bio-sensors configured to detect a target, which is a biomaterial, are disposed, the bio-sensor array comprising:
a substrate;
a plurality of island electrodes disposed on the substrate;
a common electrode configured to surround the plurality of island electrodes disposed on the substrate and not in electrical contact with the plurality of island electrodes; and
probes randomly disposed on the substrate, the plurality of island electrodes, and the common electrode and specifically coupled to the target,
wherein, surface areas of the plurality of island electrodes are smaller than that of the common electrode.

19. The bio-sensor array of claim 18, wherein the probes are sprayed and disposed on the substrate, the plurality of island electrodes, and the common electrode.
